(19) United States
(12) Patent Application Publication
(10) Pub. No.: US 2009/0248262 A1
(43) Pub. Date: Oct. 1, 2009

(54) CONTROL DEVICE AND CONTROL METHOD FOR CONTINUOUSLY VARIABLE TRANSMISSION

(75) Inventors: Kunio HATTORI, Toyota-shi (JP); Shinya TOYODA, Nisshin-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/363,075

(22) Filed: Jan. 30, 2009

(30) Foreign Application Priority Data
Mar. 26, 2008 (JP) 2008-081318

(51) Int. Cl. F16H 61/66; G06F 17/00

(52) U.S. Cl. 701/55

(57) ABSTRACT

An ECU executes a program including steps of setting an upper limit value of a target revolution number of a primary pulley revolution number NIN in the case where an oil temperature THO is greater than a threshold value; setting the upper limit value as a target revolution number in the case where the target revolution number set using the map is greater than the upper limit value; and controlling primary pulley revolution number NIN to be the target revolution number.

This nonprovisional application is based on Japanese Patent Application No. 2008-081318 filed on Mar. 26, 2008, with the Japan Patent Office, the entire contents of which are hereby incorporated by reference.

### BACKGROUND OF THE INVENTION

1. Field of the Invention

The present invention relates to a control device and a control method for a continuously variable transmission, and particularly to a technique for setting an upper limit value of a target input shaft revolution number (speed) of a continuously variable transmission according to an output shaft revolution number.

2. Description of the Background Art

Conventionally, a continuously variable transmission (CVT) such as a belt-type continuously variable transmission is known which continuously shifts a gear ratio by changing the width of each of a primary pulley and a secondary pulley coupled by a metal belt. In the vehicle equipped with this belt-type continuously variable transmission, ATF (Automatic Transmission Fluid) is supplied to the hydraulic cylinder of the primary pulley or discharged from the hydraulic cylinder to thereby change the width of the pulleys for shifting the gear ratio.

The temperature of the ATF used for the continuously variable transmission may be increased by the heat emitted from the continuously variable transmission. The viscosity of the ATF may vary according to the temperature. Subsequently, the excessive increase in the temperature of the ATF may cause deterioration in the controllability of the continuously variable transmission. Thus, it becomes necessary to limit an increase in the temperature of the ATF.

Japanese Patent Laying-Open No. 9-217824 discloses a shift control apparatus of a continuously variable transmission for performing the shift control to achieve a gear ratio with which the input revolution number (input shaft revolution number) is reduced to the set revolution number, in the case where the continuously variable transmission is in the manual range, the ATF temperature is equal to or higher than a first set value, and the input revolution number is equal to or higher than the set revolution number.

According to the shift control apparatus disclosed in the above publication, the input side revolution number is limited to be equal to or lower than the set revolution number, which allows prevention of an increase in the ATF temperature.

The heat amount generated in the continuously variable transmission varies depending on the driving state. Accordingly, even if the input shaft revolution number is decreased as in the shift control apparatus disclosed in Japanese Patent Laying-Open No. 9-217824, the heat amount of the continuously variable transmission may be large. In this case, the temperature of the ATF may be increased.

### SUMMARY OF THE INVENTION

An object of the present invention is to provide a control device and a control method for a continuously variable transmission capable of maintaining the temperature of the ATF at the appropriate level.

An aspect of a control device for a continuously variable transmission includes a revolution number sensor detecting an output shaft revolution number of the continuously variable transmission and a control unit. The control unit sets an upper limit value of a target input shaft revolution number of the continuously variable transmission according to the output shaft revolution number of the continuously variable transmission, sets the target input shaft revolution number to be equal to or lower than the upper limit value, and controls an input shaft revolution number of the continuously variable transmission to be the target input shaft revolution number.

According to the above-described configuration, the upper limit value of the target input shaft revolution number of the continuously variable transmission is set according to the output shaft revolution number of the continuously variable transmission. The target input shaft revolution number is set to be equal to or lower than the upper limit value. The input shaft revolution number of the continuously variable transmission is controlled to be the target input shaft revolution number. For example, the gear ratio is reduced. This allows the input shaft revolution number of the continuously variable transmission to be controlled according to the output shaft revolution number which has an effect on the heat amount of the continuously variable transmission. Accordingly, for example, in the driving state where the output shaft revolution number is high and the heat amount is likely to be large, the up-shift is performed to thereby decrease the input shaft revolution number, allowing the heat amount to be limited. Therefore, the temperature of the ATF can be maintained at the appropriate level.

Preferably, the control unit sets an upper limit value to be lower as the output shaft revolution number of the continuously variable transmission is higher.

According to the above-described configuration, in the driving state where the output shaft revolution number is high and the heat amount is likely to be large, the input shaft revolution number is decreased to allow the heat amount to be limited.

More preferably, the control device for the continuously variable transmission further includes a temperature sensor detecting a temperature of ATF supplied to the continuously variable transmission. In the case where the temperature of the ATF is greater than a threshold value, the control unit sets the upper limit value according to the output shaft revolution number.

According to the above-described configuration, in the case where the temperature of the ATF is greater than the threshold value, the upper limit value of the target input shaft revolution number is set according to the output shaft revolution number. Thus, in the case where the controllability of the continuously variable transmission may deteriorate due to the high temperature of the ATF, the heat amount can be limited. Consequently, the controllability of the continuously variable transmission can be less likely to deteriorate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram of a power train of a vehicle.

FIG. 2 is a control block diagram of an ECU.

FIG. 3 is a (first) diagram of a hydraulic control circuit.

FIG. 4 is a (second) diagram of the hydraulic control circuit.

FIG. 5 is a (third) diagram of the hydraulic control circuit.

FIG. 6 is a diagram of the relationship between a target revolution number of a primary pulley revolution number NIN of a continuously variable transmission and a vehicle speed V.

FIG. 7 is a functional block diagram of the ECU.

FIG. 8 is a flowchart of the control structure of the program executed by the ECU.

### DESCRIPTION OF THE PREFERRED EMBODIMENTS

The embodiments of the present invention will be hereinafter described with reference to the accompanying drawings, in which the same components are designated by the same reference characters and have the same names and functions, and therefore, description thereof will not be repeated.

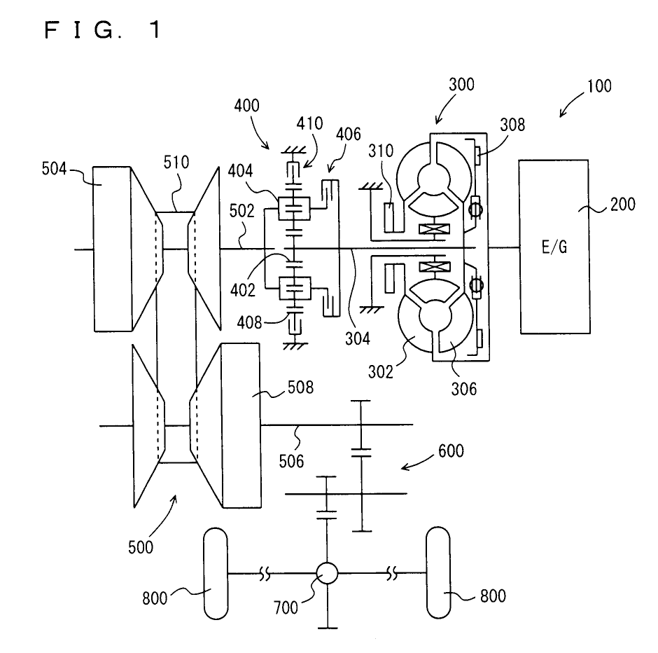

Referring to FIG. 1, the vehicle equipped with a control device according to the present embodiment will be described. The output power of an engine 200 of a power train 100 mounted in the vehicle is input to a continuously variable transmission 500 through a torque converter 300 and a forward and backward movement switching device 400. The output power of continuously variable transmission 500 is transmitted to a reduction gear 600 and a differential gear 700, and distributed to a driving wheel 800 on each of the right and left sides. Power train I 00 is controlled by an ECU (Electronic Control Unit) 900 described below.

Torque converter 300 includes a pump impeller 302 coupled to the crankshaft of engine 200 and a turbine runner 306 coupled to forward and backward movement switching device 400 via a turbine shaft 304. A lock-up clutch 308 is provided between pump impeller 302 and turbine runner 306. Lock-up clutch 308 is engaged or disengaged when the supply of the hydraulic oil pressure to the oil chamber is switched between the engagement side and the disengagement side.

When lock-up clutch 308 is completely engaged, pump impeller 302 and turbine runner 306 are integrally rotated. Pump impeller 302 is provided with a mechanical oil pump 310 which generates hydraulic oil pressure for performing the shift control of continuously variable transmission 500, generating the belt holding pressure by which the belt is pressed laterally from both sides and supplying the ATF for lubrication to each unit.

Forward and backward movement switching device 400 includes a double-pinion type planetary gear train. Turbine shaft 304 of torque converter 300 is coupled to a sun gear 402. An input shaft 502 of continuously variable transmission 500 is coupled to a carrier 404, Carrier 404 and sun gear 402 are coupled to each other through a forward clutch 406. A ring gear 408 is fixed to a housing via a reverse brake 410. Forward clutch 406 and reverse brake 410 are frictionally engaged by a hydraulic cylinder. The input revolution number of forward clutch 406 is equal to the revolution number of turbine shaft 304, that is, a turbine revolution number NT.

Forward clutch 406 is engaged and reverse brake 410 is disengaged, to thereby cause forward and backward movement switching device 400 to be in the engaged state for forward running. In this state, the driving force in the forward direction is transmitted to continuously variable transmission 500. Reverse brake 410 is engaged and forward clutch 406 is disengaged, to thereby cause forward and backward movement switching device 400 to be in the engaged state for backward running. In this state, input shaft 502 is rotated in the opposite direction relative to turbine shaft 304. This causes the driving force in the backward direction to be transmitted to continuously variable transmission 500. When forward clutch 406 and reverse brake 410 are both disengaged, forward and backward movement switching device 400 goes into the neutral state in which power transmission is interrupted.

Continuously variable transmission 500 includes a primary pulley 504 provided for input shaft 502, a secondary pulley 508 provided for an output shaft 506, and a belt 510 wound around these pulleys. The friction force between each pulley and belt 510 is used for power transmission.

Each pulley is configured from the hydraulic cylinder such that its groove has a variable width. The hydraulic oil pressure of the hydraulic cylinder of primary pulley 504 is controlled to change the groove width of each pulley. This causes a change in the effective diameter of belt 510 and thus allows a continuous change in a gear ratio GR (=a primary pulley revolution number NIN/a secondary pulley revolution number NOUT). It is to be noted that a chain-type or a toroidal-type continuously variable transmission may be used instead of a belt-type continuously variable transmission 500.

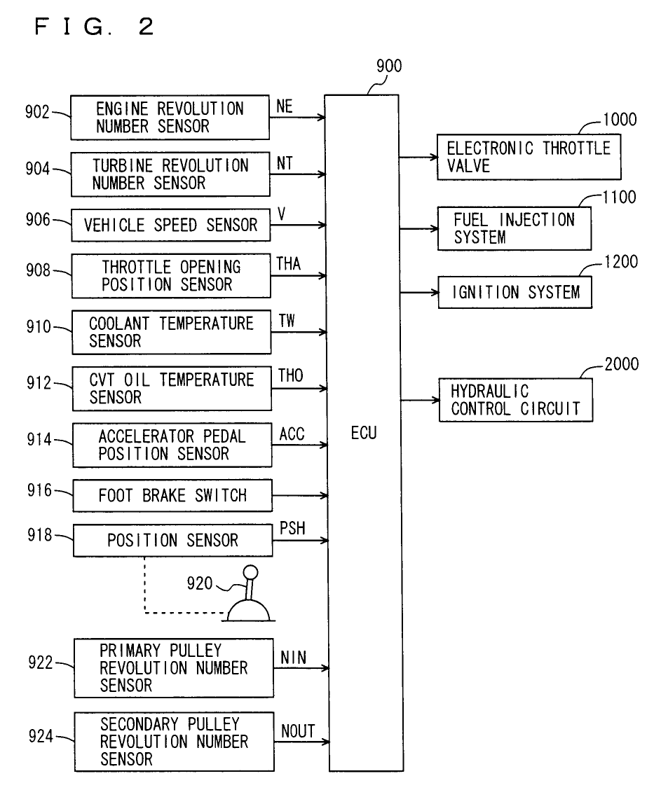

As shown in FIG. 2, connected to ECU 900 is an engine revolution number sensor 902, a turbine revolution number sensor 904, a vehicle speed sensor 906, a throttle opening position sensor 908, a coolant temperature sensor 910, an oil temperature sensor 912, an accelerator pedal position sensor 914, a foot brake switch 916, a position sensor 918, a primary pulley revolution number sensor 922, and a secondary pulley revolution number sensor 924.

Engine revolution number sensor 902 detects a revolution number (engine revolution number) NE of engine 200. Turbine revolution number sensor 904 detects a revolution number (turbine revolution number) NT of turbine shaft 304. Vehicle speed sensor 906 detects a vehicle speed V. Throttle opening position sensor 908 detects an opening position THA of the electronic throttle valve. Coolant temperature sensor 910 detects a coolant temperature TW of engine 200. Oil temperature sensor 912 detects a temperature of the ATF (hereinafter also referred to as an oil temperature) THO that is used for actuating continuously variable transmission 500. Accelerator pedal position sensor 914 detects an accelerator pedal position ACC. Foot brake switch 916 detects whether the foot brake is operated or not. Position sensor 918 detects a position PSH of a shift lever 920 by determining whether the contact point provided in the position corresponding to the shift position is ON or OFF. Primary pulley revolution number sensor 922 detects a revolution number (input shaft revolution number) NIN of primary pulley 504. Secondary pulley revolution number sensor 924 detects a revolution number (output shaft revolution number) NOUT of secondary pulley 508. The signal indicating the detection result of each sensor is transmitted to ECU 900. During forward running in which forward clutch 406 is engaged, turbine revolution number NT is equal to primary pulley revolution number NIN. Vehicle speed V attains a value corresponding to secondary pulley revolution number NOUT. Consequently, in the state where the vehicle is at a standstill and forward clutch 406 is engaged, turbine revolution number NT becomes 0.

ECU 900 includes a CPU (Central Processing Unit), a memory, an input/output interface, and the like. The CPU performs signal processing in accordance with the program stored in the memory, to thereby carry out the output power control of engine 200, the shift control of continuously variable transmission 500, the control of the belt holding pressure, the engagement/disengagement control of forward clutch 406, the engagement/disengagement control of reverse brake 410, and the like.

The output power of engine 200 is controlled by an electronic throttle valve 1000, a fuel injection system 1100, an ignition system 1200, and the like. A hydraulic control circuit 2000 carries out the shift control of continuously variable transmission 500, the control of the belt holding pressure, the engagement/disengagement control of forward clutch 406, and the engagement/disengagement control of reverse brake 410.

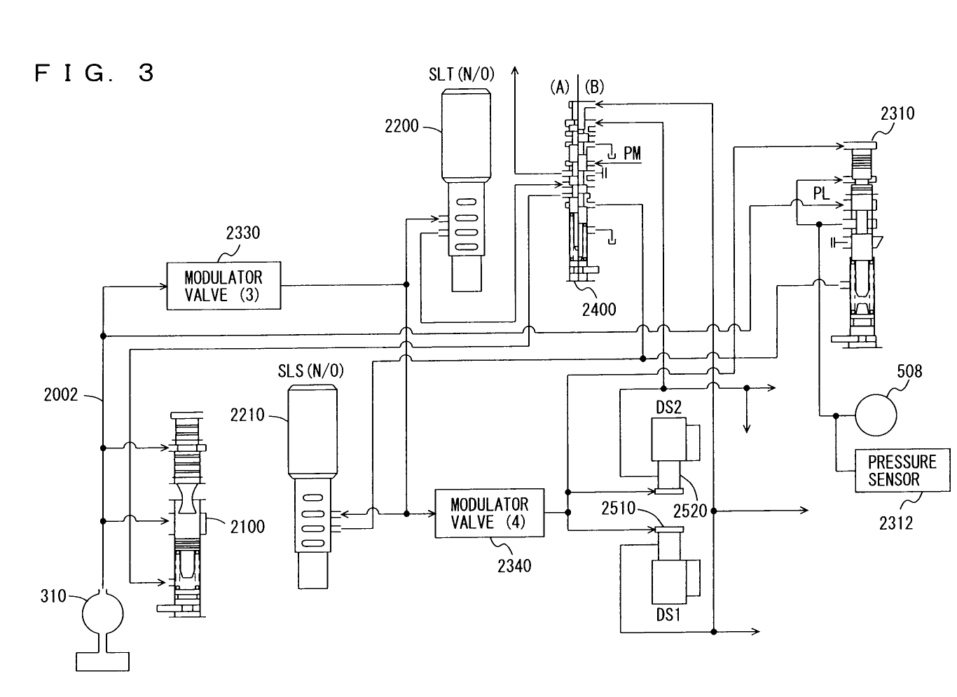

Referring to FIG. 3, a part of hydraulic control circuit 2000 will then be described. It is to be noted that hydraulic control circuit 2000 described below is merely an example and is not limited thereto.

The hydraulic oil pressure generated by oil pump 310 is supplied via a line pressure oil passage 2002 to a primary regulator valve 2100, a modulator valve (1) 2310, and a modulator valve (3) 2330.

Primary regulator valve 2100 receives the control pressure selectively from one of an SLT linear solenoid valve 2200 and an SLS linear solenoid valve 2210. In the present embodiment, SLT linear solenoid valve 2200 and SLS linear solenoid valve 2210 each are a normal-open type solenoid valve (the hydraulic oil pressure output at the time of non-energization is highest). It is to be noted that SLT linear solenoid valve 2200 and SLS linear solenoid valve 2210 may be of a normal-close type (the hydraulic oil pressure output at the time of non-energization is lowest (becomes “0”).

The spool of primary regulator valve 2100 slides up and down depending on the supplied control pressure, with the result that the hydraulic oil pressure generated in oil pump 310 is adjusted by primary regulator valve 2100. The hydraulic oil pressure adjusted by primary regulator valve 2100 is used as a line pressure PL. In the present embodiment, line pressure PL becomes higher as the control pressure supplied to primary regulator valve 2100 becomes higher. It is to be noted that line pressure PL may become lower as the control pressure supplied to primary regulator valve 2100 becomes higher.

The hydraulic oil pressure adjusted by modulator valve (3) 2330 using line pressure PL as an original pressure is supplied to SLT linear solenoid valve 2200 and SLS linear solenoid valve 2210.

SLT linear solenoid valve 2200 and SLS linear solenoid valve 2210 generate control pressure according to the current value determined by the duty signal (duty value) transmitted from ECU 900.

The control pressure supplied to primary regulator valve 2100 is selected by a control valve 2400 from the control pressure (output hydraulic oil pressure) of SLT linear solenoid valve 2200 and the control pressure (output hydraulic oil pressure) of SLS linear solenoid valve 2210.

When the spool of control valve 2400 is in the (A) state (on the left side) in FIG. 3, the control pressure is supplied from SLT linear solenoid valve 2200 to primary regulator valve 2100. In other words, line pressure PL is controlled according to the control pressure of SLT linear solenoid valve 2200.

When the spool of control valve 2400 is in the (B) state (on the right side) in FIG. 3, the control pressure is supplied from SLS linear solenoid valve 2210 to primary regulator valve 2100. In other words, line pressure PL is controlled according to the control pressure of SLS linear solenoid valve 2210.

It is to be noted that, when the spool of control valve 2400 is in the (B) state in FIG. 3, the control pressure of SLT linear solenoid valve 2200 is supplied to a manual valve 2600 described below.

The spool of control valve 2400 is biased in one direction by a spring. The hydraulic oil pressure is supplied from a shift controlling duty solenoid (1) 2510 and a shift controlling duty solenoid (2) 2520 so as to oppose the biasing force of this spring.

Shift controlling duty solenoid (1) 2510 and shift controlling duty solenoid (2) 2520 output the hydraulic oil pressure (control pressure) in accordance with the current value determined by the duty signal (duty value) transmitted from ECU 900.

In the case where shift controlling duty solenoid (1) 2510 and shift controlling duty solenoid (2) 2520 each supply the hydraulic oil pressure to control valve 2400, the spool of control valve 2400 goes into the (B) state in FIG. 3.

In the case where at least one of shift controlling duty solenoid (1) 2510 and shift controlling duty solenoid (2) 2520 does not supply the hydraulic oil pressure to control valve 2400, the spool of control valve 2400 goes into the (A) state in FIG. 3 by the biasing force of the spring.

The hydraulic oil pressure adjusted by a modulator valve (4) 2340 is supplied to shift controlling duty solenoid (1) 2510 and shift controlling duty solenoid (2) 2520. Modulator valve (4) 2340 adjusts the hydraulic oil pressure supplied from modulator valve (3) 2330 to a constant pressure.

Modulator valve (1) 2310 outputs the hydraulic oil pressure that is adjusted using line pressure PL as an original pressure. The hydraulic oil pressure output from modulator valve (1) 2310 is supplied to the hydraulic cylinder of secondary pulley 508. The hydraulic oil pressure which prevents sliding of belt 510 is supplied to the hydraulic cylinder of secondary pulley 508.

Modulator valve (1) 2310 is provided with a spool capable of moving in the axial direction and a spring biasing the spool in one direction. Modulator valve (1) 2310 adjusts line pressure PL introduced into modulator valve (1) 2310 using, as a pilot pressure, the output hydraulic oil pressure of SLS linear solenoid valve 2210 duty-controlled by ECU 900. The hydraulic oil pressure adjusted by modulator valve (3) is supplied to the hydraulic cylinder of secondary pulley 508. The belt holding pressure is increased or decreased according to the output hydraulic oil pressure from modulator valve (1) 2310.

According to the map including accelerator pedal position ACC and gear ratio GR each as a parameter, SLS linear solenoid valve 2210 is controlled to achieve the belt holding pressure which prevents sliding of the belt. Specifically, the exciting current for SLS linear solenoid valve 2210 is controlled by the duty ratio corresponding to the belt holding pressure. In the case where the transmission torque changes abruptly during acceleration, deceleration and the like, the belt holding pressure may be adjusted to be increased for suppressing the sliding of the belt.

The hydraulic oil pressure supplied to the hydraulic cylinder of secondary pulley 508 is detected by a pressure sensor 2312.

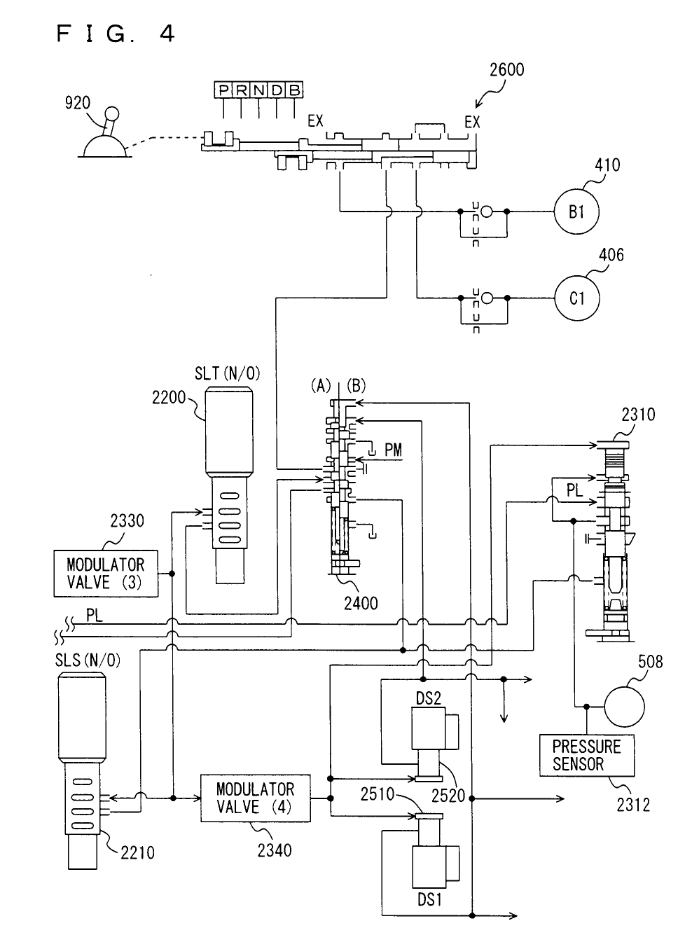

Referring to FIG. 4, manual valve 2600 will then be described. Manual valve 2600 is mechanically switched according to the operation of shift lever 920. This causes forward clutch 406 and reverse brake 410 to be engaged or disengaged.

Shift lever 920 is operated to a “P” position for parking, an “R” position for backward running, an “N” position in which the power transmission is interrupted, and a “D” position and a “B” position for forward running.

In the “P” position and the “N” position, the hydraulic oil pressure within forward clutch 406 and reverse brake 410 is drained from manual valve 2600, causing forward clutch 406 and reverse brake 410 to be disengaged.

In the “R” position, the hydraulic oil pressure is supplied from manual valve 2600 to reverse brake 410, causing reverse brake 410 to be engaged. Meanwhile, the hydraulic oil pressure within forward clutch 406 is drained from manual valve 2600, causing forward clutch 406 to be disengaged.

In the case where control valve 2400 is in the (A) state (on the left side) in FIG. 4, a modulator pressure PM supplied from a modulator valve (2) which is not shown is supplied to manual valve 2600 through control valve 2400. This modulator pressure PM serves to hold reverse brake 410 in the engaged state.

In the case where control valve 2400 is in the (B) state (on the right side) in FIG. 4, the hydraulic oil pressure adjusted by SLT linear solenoid valve 2200 is supplied to manual valve 2600. The adjustment of the hydraulic oil pressure by SLT linear solenoid valve 2200 causes reverse brake 410 to be gently engaged, leading to suppression of the impact at the time of engagement.

Furthermore, in the case where control valve 2400 is in the (B) state (on the right side) in FIG. 4, as the duty ratio of SLT linear solenoid valve 2200 is set to 100% and the amount of energization is maximized, SLT linear solenoid valve 2200 ceases from outputting the hydraulic oil pressure and the hydraulic oil pressure to be supplied to reverse brake 410 becomes “0”. In other words, the hydraulic oil pressure is drained from reverse brake 410 through SLT linear solenoid valve 2200 to disengage reverse brake 410.

In the “D” position and the “B” position, the hydraulic oil pressure is supplied from manual valve 2600 to forward clutch 406, causing forward clutch 406 to be engaged. Meanwhile, the hydraulic oil pressure within reverse brake 410 is drained from manual valve 2600, causing reverse brake 410 to be disengaged.

In the case where control valve 2400 is in the (A) state (on the left side) in FIG. 4, modulator pressure PM supplied from modulator valve (2) which is not shown is supplied to manual valve 2600 through control valve 2400. This modulator pressure PM serves to hold forward clutch 406 in the engaged state.

In the case where control valve 2400 is in the (B) state (on the right side) in FIG. 4, the hydraulic oil pressure adjusted by SLT linear solenoid valve 2200 is supplied to manual valve 2600. The adjustment of the hydraulic oil pressure by SLT linear solenoid valve 2200 causes forward clutch 406 to be gently engaged, leading to suppression of the impact at the time of engagement.

SLT linear solenoid valve 2200 usually controls line pressure PL via control valve 2400. SLS linear solenoid valve 2210 usually controls the belt holding pressure via modulator valve (1) 2310.

In the case where the neutral control execution condition is satisfied including the condition that the vehicle is stopped in the state where shift lever 920 is in the “D” position (the vehicle speed becomes “0”), SLT linear solenoid valve 2200 controls the engaging force of forward clutch 406 to be decreased. SLS linear solenoid valve 2210 controls the belt holding pressure via modulator valve (1) 2310 and also controls line pressure PL on behalf of SLT linear solenoid valve 2200.

When the garage shift is performed in which shift lever 920 is operated from the “N” position to the “D” position or the “R” position, SLT linear solenoid valve 2200 controls the engaging force of forward clutch 406 or reverse brake 410 so as to cause a gentle engagement of forward clutch 406 or reverse brake 410. SLS linear solenoid valve 2210 controls the belt holding pressure via modulator valve (1) 2310 and also controls line pressure PL on behalf of SLT linear solenoid valve 2200.

In the case where shift lever 920 is operated to the “R” position during forward running of the vehicle (when the vehicle speed is equal to or higher than a recovery speed V (R)), SLT linear solenoid valve 2200 is controlled to disengage reverse brake 410.

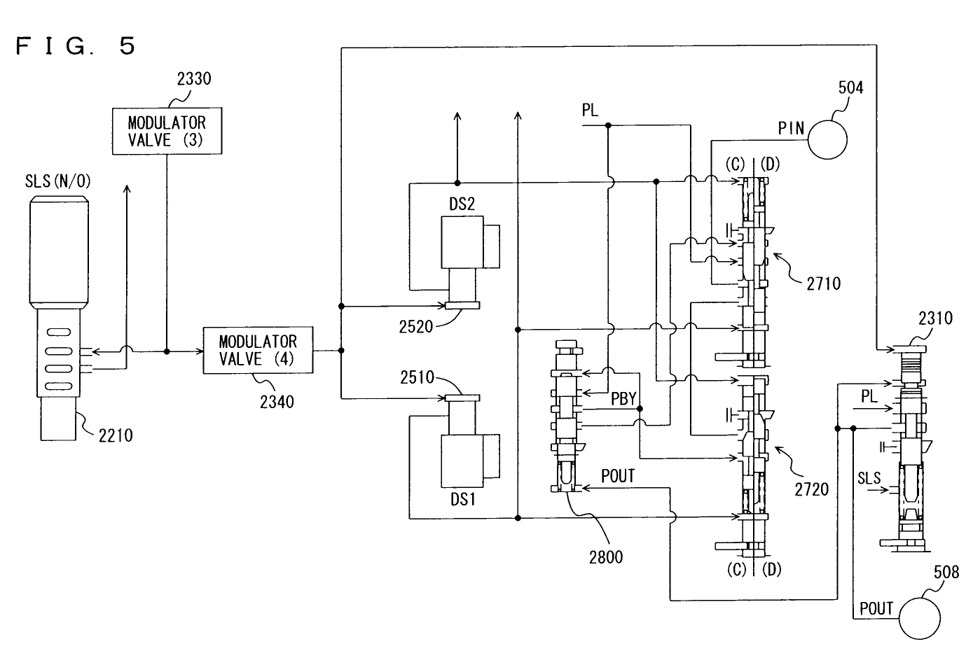

Referring to FIG. 5, the configuration for the shift control will then be described. The shift control is performed by controlling the supply and discharge of the hydraulic oil pressure to and from the hydraulic cylinder of primary pulley 504. A ratio control valve (1) 2710 and a ratio control valve (2) 2720 are used to supply and discharge the ATF to and from the hydraulic cylinder of primary pulley 504.

The hydraulic cylinder of primary pulley 504 is in communication with ratio control valve (1) 2710 receiving line pressure PL and ratio control valve (2) 2720 connected to a drain.

Ratio control valve (1) 2710 serves as a valve for an up-shift. Ratio control valve (1) 2710 is configured such that the channel between the input port receiving line pressure PL and the output port communicated with the hydraulic cylinder of primary pulley 504 is opened and closed by the spool.

The spool of ratio control valve (1) 2710 has one end provided with a spring. On the end opposite to the spring across the spool, a port receiving the control pressure from shift controlling duty solenoid (1) 2510 is formed. On the end on which the spring is provided, a port receiving the control pressure from shift controlling duty solenoid (2) 2520 is formed.

If the control pressure from shift controlling duty solenoid (1) 2510 is set to be increased and shift controlling duty solenoid (2) 2520 ceases from outputting the control pressure, the spool of ratio control valve (1) 2710 goes into the (D) state (on the right side) in FIG. 5.

In this state, the hydraulic oil pressure supplied to the hydraulic cylinder of primary pulley 504 increases to cause a reduction in the groove width of primary pulley 504. This causes gear ratio GR to be decreased, that is, the up-shift to be caused. An increase in the supply flow rate of the ATF at that time also causes an increase in the shift speed.

Ratio control valve (2) 2720 serves as a valve for a down-shift. The spool of ratio control valve (2) 2720 has one end provided with a spring. On the end on which the spring is provided, a port receiving the control pressure from shift controlling duty solenoid (1) 2510 is formed. On the end opposite to the spring across the spool, a port receiving the control pressure from shift controlling duty solenoid (2) 2520 is formed.

When the control pressure from shift controlling duty solenoid (2) 2520 is set to be increased and shift controlling duty solenoid (1) 2510 ceases from outputting the control pressure, the spool of ratio control valve (2) 2720 goes into the (C) state (on the left side) in FIG. 5. The spool of ratio control valve (1) 2710 also goes into the (C) state (on the left side) in FIG. 5.

In this state, the ATF is discharged through ratio control valve (1) 2710 and ratio control valve (2) 2720 from the hydraulic cylinder of primary pulley 504. This increases the groove width of primary pulley 504, causing gear ratio GR to be increased, that is, the down-shift to be caused. An increase in the discharge flow rate of the ATF at that time also causes an increase in the shift speed.

When gear ratio GR is controlled, the hydraulic oil pressure (control pressure) output from shift controlling duty solenoid (1) 2510 and the hydraulic oil pressure (control pressure) output from shift controlling duty solenoid (2) 2520 each reach a value in accordance with the duty value transmitted from ECU 900 to each shift controlling duty solenoid.

In the present embodiment, the control pressure of the shift controlling duty solenoid becomes higher as the duty value becomes higher. The duty value is determined according to the difference between the actual revolution number of input shaft 502 of continuously variable transmission 500 and the target revolution number set in accordance with the map and the like described below. The duty value is set to be higher as the difference between the actual revolution number of input shaft 502 and the target revolution number is larger.

In ratio control valve (1) 2710, if the force acting on the spool by the hydraulic oil pressure output from shift controlling duty solenoid (1) 2510 is smaller than the sum of the force acting on the spool by the hydraulic oil pressure output from shift controlling duty solenoid (2) 2520 and the biasing force of the spring, the spool of ratio control valve (1) 2710 goes into the (C) state (on the left side).

In ratio control valve (2) 2720, if the force acting on the spool by the hydraulic oil pressure output from shift controlling duty solenoid (2) 2520 is smaller than the sum of the force acting on the spool by the hydraulic oil pressure output from shift controlling duty solenoid (1) 2510 and the biasing force of the spring, the spool of ratio control valve (2) 2720 goes into the (D) state (on the right side).

Therefore, when shift controlling duty solenoid (1) 2510 and shift controlling duty solenoid (2) 2520 each cease from outputting the control pressure, the spool of ratio control valve (1) 2710 goes into the (C) state (on the left side) and the spool of ratio control valve (2) 2720 also goes into the (D) state (on the right side).

In this state, the hydraulic oil pressure adjusted by a bypass control valve 2800 connected to ratio control valve (2) 2720 is supplied to the hydraulic cylinder of primary pulley 504. In other words, the flow rate of the ATF supplied to the hydraulic cylinder of primary pulley 504 is controlled by bypass control valve 2800.

The spool of bypass control valve 2800 has one end provided with a spring. This spring biases the spool in a direction such that the input port receiving line pressure PL and the output port outputting a hydraulic oil pressure (hydraulic oil pressure adjusted by bypass control valve 2800) PBY eventually supplied to the hydraulic cylinder of primary pulley 504 are in communication with each other.

On the end on which the spring is provided, a port receiving an output hydraulic oil pressure POUT from modulator valve (1)2310 is formed. On the end opposite to the spring across the spool, a feedback port is formed to which hydraulic oil pressure POUT output from bypass control valve 2800 is fed back.

Assuming that the cross-sectional area on the feedback port side is A (1), the cross-sectional area on the port side receiving hydraulic oil pressure POUT from modulator valve (1) 2310 is A (2) and the biasing force of the spring is W, bypass control valve 2800 is to be held in equilibrium by the following equation.

PBY×A(1)=POUT×A(2)+W (1)

If this equation is modified, hydraulic oil pressure PBY output from bypass control valve 2800 is expressed by the following equation.

PBY={A(2)/A(1)}×POUT+W/A(1) (2)

Thus, the hydraulic oil pressure expressed by the equation (2) having a term of {A (2)/A (1)}×POUT is input to ratio control valve (2) 2720.

Accordingly, in the case where the spool of ratio control valve (1) 2710 is in the (C) state (on the left side) and the spool of ratio control valve (2) 2720 is in the (D) state (on the right side), the hydraulic oil pressure according to hydraulic oil pressure POUT output for controlling the belt holding pressure can be eventually supplied to the hydraulic cylinder of primary pulley 504.

When the ATF leaks from the hydraulic control circuit, the hydraulic control equipment and the like to cause a decrease in the hydraulic oil pressure of the hydraulic cylinder of primary pulley 504, the ATF is supplied little by little from bypass control valve 2800 to the hydraulic cylinder of primary pulley 504. Accordingly, the gear ratio shifting shows a tendency of a slight up-shift, leading to a slow up-shift in which gear ratio GR is decreased little by little.

Gear ratio GR under normal conditions is controlled such that primary pulley revolution number NIN reaches a target revolution number set using the map. The target revolution number is set using the map including vehicle speed V and accelerator pedal position ACC each as a parameter.

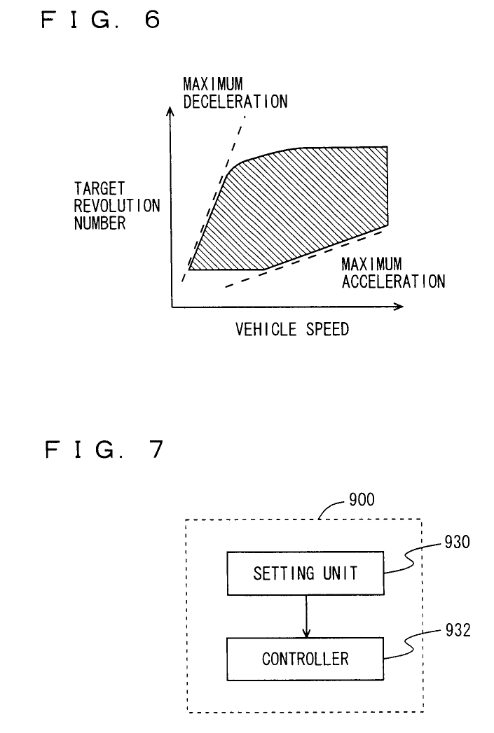

When shift lever 920 is in the “D” position, the target revolution number can take a value within the diagonally shaded area shown in FIG. 6. In other words, gear ratio GR may vary between the highest gear ratio and the lowest gear ratio among the gear ratios set in continuously variable transmission 500.

However, as described below, if oil temperature THO is higher than a threshold value, the target revolution number is limited to be equal to or lower than the upper limit value determined according to secondary pulley revolution number NOUT of continuously variable transmission 500.

Referring to FIG. 7, the function of ECU 900 will then be described. It is to be noted that the function described below may be implemented by software or may be implemented by hardware.

ECU 900 includes a setting unit 930 and a controller 932. Setting unit 930 sets the upper limit value of the target revolution number and the target revolution number. The upper limit value of the target revolution number is determined according to secondary pulley revolution number NOUT. In the present embodiment, an upper limit value is set to be lower as the secondary pulley revolution number NOUT is higher.

In the case where the target revolution number set using the map described above is equal to or higher than the upper limit value, the upper limit value is set as a target revolution number. In the case where the target revolution number set using the map is less than the upper limit value, the target revolution number set using the map is used.

Controller 932 controls gear ratio GR of continuously variable transmission 500 such that primary pulley revolution number NIN reaches the target revolution number.

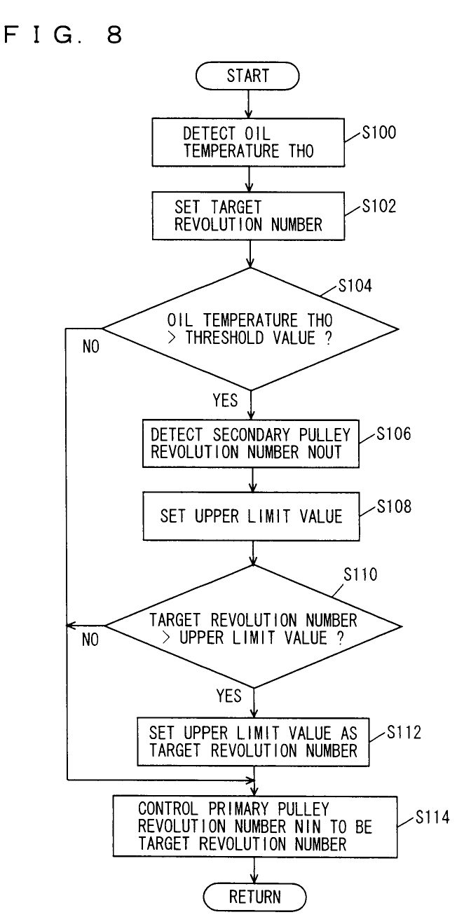

Referring to FIG. 8, the control structure of the program executed by ECU 900 of the control device according to the present embodiment will then be described. It is to be noted that the program executed by ECU 900 may be recorded on the recording medium such as a CD (Compact Disc) and a DVD (Digital Versatile Disc) and distributed to the market.

In step (hereinafter abbreviated as S) 100, ECU 900 detects oil temperature THO based on the signal transmitted from oil temperature sensor 912.

In S102, ECU 900 sets the target revolution number of primary pulley revolution number NIN based on the map including vehicle speed V and accelerator pedal position ACC each as a parameter.

In S104, ECU 900 determines whether oil temperature THO is higher than the threshold value. If oil temperature THO is higher than the threshold value (YES in S104), the process proceeds to S106. If not (NO in S104), the process proceeds to S114.

In S106, ECU 900 detects secondary pulley revolution number NOUT based on the signal transmitted from secondary pulley revolution number sensor 924. In S108, ECU 900 sets the upper limit value of the target revolution number according to secondary pulley revolution number NOUT. In the present embodiment, an upper limit value is set to be lower as the secondary pulley revolution number NOUT is higher.

In S110, ECU 900 determines whether the target revolution number set using the map is higher than the upper limit value. If the target revolution number set using the map is higher than the upper limit value (YES in S110), the process proceeds to S112. If not (NO in S110), the process proceeds to S114. In S112, ECU 900 sets the upper limit value as a target revolution number.

In S114, ECU 900 controls primary pulley revolution number NIN to be the target revolution number.

The operations of the control device according to the present embodiment based on the structures and flow charts as described above will then be described.

During the vehicle running, oil temperature THO is detected based on the signal transmitted from oil temperature sensor 912 (S100). Furthermore, based on the map including vehicle speed V and accelerator pedal position ACC each as a parameter, the target revolution number of primary pulley revolution number NIN is set (S102).

If oil temperature THO is higher than the threshold value (YES in S104), secondary pulley revolution number NOUT is detected (S106) and the upper limit value of the target revolution number of primary pulley revolution number NIN is set according to secondary pulley revolution number NOUT (S108). An upper limit value is set to be lower as the secondary pulley revolution number NOUT is higher.

If the target revolution number set using the map is equal to or lower than the upper limit value (NO in S110), primary pulley revolution number NIN is controlled to be the target revolution number set using the map (S114).

If the target revolution number set using the map is greater than the upper limit value (YES in S110), the upper limit value is set as a target revolution number (S112) and primary pulley revolution number NIN is controlled to be the target revolution number (S114). In other words, primary pulley revolution number NIN is controlled to be the upper limit value.

Consequently, primary pulley revolution number NIN can be controlled according to secondary pulley revolution number NOUT which has an effect on the heat amount generated in continuously variable transmission 500. In the present embodiments, in the driving state in which the heat amount of continuously variable transmission 500 is likely to increase due to the increased secondary pulley revolution number NOUT, for example, primary pulley revolution number NIN is decreased by the up-shift to allow the heat amount to be limited. Therefore, the temperature of the ATF used for actuating continuously variable transmission 500 can be maintained at the appropriate level.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A control device for a continuously variable transmission, comprising:
a revolution number sensor detecting an output shaft revolution number of said continuously variable transmission; and
a control unit, wherein
said control unit sets an upper limit value of a target input shaft revolution number of said continuously variable transmission according to the output shaft revolution number of said continuously variable transmission,
said control unit sets said target input shaft revolution number to be equal to or lower than said upper limit value, and
said control unit controls an input shaft revolution number of said continuously variable transmission to be said target input shaft revolution number.

2. The control device for the continuously variable transmission according to claim 1, wherein said control unit sets an upper limit value to be lower as the output shaft revolution number of said continuously variable transmission is higher.

3. The control device for the continuously variable transmission according to claim 1, further comprising an oil temperature sensor detecting a temperature of ATF supplied to said continuously variable transmission, wherein
in a case where the temperature of said ATF is higher than a threshold value, said control unit sets said upper limit value according to said output shaft revolution number.

4. A control device for a continuously variable transmission, comprising:
means for detecting an output shaft revolution number of said continuously variable transmission;
means for setting an upper limit value of a target input shaft revolution number of said continuously variable transmission according to the output shaft revolution number of said continuously variable transmission;
means for setting said target input shaft revolution number to be equal to or lower than said upper limit value; and
means for controlling an input shaft revolution number of said continuously variable transmission to be said target input shaft revolution number.

5. The control device for the continuously variable transmission according to claim 4, wherein said means for setting said upper limit value includes means for setting an upper limit value to be lower as the output shaft revolution number of said continuously variable transmission is higher.

6. The control device for the continuously variable transmission according to claim 4, further comprising means for detecting a temperature of ATF supplied to said continuously variable transmission, wherein
said means for setting said upper limit value includes means for setting said upper limit value according to said output shaft revolution number in a case where the temperature of said ATF is higher than a threshold value.

7. A control method for a continuously variable transmission, comprising the steps of:
detecting an output shaft revolution number of said continuously variable transmission;
setting an upper limit value of a target input shaft revolution number of said continuously variable transmission according to the output shaft revolution number of said continuously variable transmission;
setting said target input shaft revolution number to be equal to or lower than said upper limit value; and
controlling an input shaft revolution number of said continuously variable transmission to be said target input shaft revolution number.

8. The control method for the continuously variable transmission according to claim 7, wherein said step of setting said upper limit value includes a step of setting an upper limit value to be lower as the output shaft revolution number of said continuously variable transmission is higher.

9. The control method for the continuously variable transmission according to claim 7, further comprising a step of detecting a temperature of ATF supplied to said continuously variable transmission, wherein
said step of setting said upper limit value includes a step of setting said upper limit value according to said output shaft revolution number in a case where the temperature of said ATF is greater than a threshold value.
